(19) United States
(12) Patent Application Publication
(10) Pub. No.: US 2004/0031478 A1
(43) Pub. Date: Feb. 19, 2004

(54) Rotatable grill assembly

(76) Inventor: Charles J. Gifford, Stillwater, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/411,585

(22) Filed: Apr. 10, 2003

Related U.S. Application Data
(60) Provisional application No. 60/372,587, filed on Apr. 15, 2002.

(51) Int. Cl. A47J 37/00

(52) U.S. Cl. 126/25 AA; 126/25 R

(57) ABSTRACT

A grill assembly including a rack assembly and an adaptor. The rack assembly includes a first rack spaced from and connected to a second rack opposite the first rack. The adaptor is adapted to attach to an exiting grill and to receive the rack assembly, wherein the rack assembly selectively rotates with respect to the adaptor.

### CROSS-REFERENCE TO RELATED APPLICATIONS

This non-provisional application claims the benefit of the filing date of Provisional U.S. patent application Ser. No. 60/372,587, entitled “Barbecue Adaptor and Rotatable Grill,” having a filing date of Apr. 15, 2002, and which is herein incorporated by reference.

### FIELD OF THE INVENTION

The present invention provides a rotatable grill assembly. More particularly, this invention relates to a rotatable grill assembly to convert an existing grill into a rotatable grill and a similar design to create a new rotatable grill.

### BACKGROUND OF THE INVENTION

Grilling is a popular method of food preparation. There are many existing styles and designs of apparatus used to grill, cook, or smoke foods. The most widely used barbecue grills are simple open or covered, round or rectangular grills. Such grills are fairly inexpensive and are typically mounted on a stand and have a wire or metal rack to receive and support the food during the grilling, cooking, or smoking process.

Although conventional grills are useful for cooking, grilling, and smoking, they require a user to stand by the grill and periodically turn each individual piece of food to cook both sides of the food and to prevent burning. During this process, the individual pieces of food are deteriorated by excessive handling. In many cases, the food sticks to the grill often breaking the food into undesirable pieces, thereby, further exacerbating food deterioration. This problem is especially problematic if the original food pieces are relatively small to begin with, such as shrimp or small chunks of meat and vegetable. Although such small items are often placed upon a skewer to aid rotation, often times the meat, seafood, or vegetable do not turn when the skewer is rotated, resulting in the food being overcooked on one side or raw on the other side.

In addition, it takes a considerable amount of time for a user to turn a large number of food pieces. During this time, the user is often subjected to large amounts of heat and smoke from the grill. This often results in the unwanted transfer of smoke odor to the user and the user's clothing.

The deficiencies associated with conventional charcoal and gas grills are frustrating to users to enjoy the taste imparted to food during the grilling, smoking, or cooking process. Therefore, for the reasons stated above and the reasons presented in greater detail in the description of the exemplary embodiment section of the present specification, a need exists for a system of cooking, smoking, or grilling which facilitates even cooking of food items and limits the amount of time that a user is exposed to the heat and smoke produced by the grill.

### SUMMARY OF THE INVENTION

One aspect of the present invention relates to a grill assembly including a rack assembly and an adaptor. The rack assembly includes a first rack spaced from and connected to a second rack opposite the first rack. The adaptor is adapted to attach to an exiting grill and is adapted to rotatably receive the rack assembly.

Another aspect of the present invention relates to a grill assembly including a rack assembly, a grill base, and an adaptor. The rack assembly includes a first rack spaced from and connected to a second rack opposite the first rack. The first rack includes at least one radially extending journal. The rack assembly is rotatable about the at least one journal. The grill base defines a cavity. The adaptor is secured to the grill base and defines at least one notch to receive the at least one radially extending journal. The at least one notch is adapted to selectively maintain the at least one radially extending journal in a plurality of distances from the grill base.

Yet another aspect of the present invention relates to a method of converting an existing grill into a rotatable grill assembly. The existing grill includes a base which defines a cavity. The method includes securing an adaptor to the base and placing A rack assembly on the adaptor. The rack assembly includes a first rack spaced from and connected to a second rack opposite the first rack. The adaptor rotatably maintains the rack assembly.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a schematic view of one embodiment of a rotatable grill assembly.

FIG. 2 is a schematic view of one embodiment of a rack assembly of the rotatable grill assembly illustrated in FIG. 1.

FIG. 3 is an end view of one embodiment of a pivot bracket of the rack assembly illustrated in FIG. 2.

FIG. 4 is a schematic view of one embodiment of a clamp of the rack assembly of FIG. 2.

FIG. 5 is a schematic view of another embodiment of a clamp of the rack assembly of FIG. 2.

FIG. 6 is a schematic view of one embodiment of a spacer assembly of the rack assembly of FIG. 2.

FIG. 7 is a schematic view of another embodiment of a clamp of the rack assembly of FIG. 2.

FIG. 8 is a schematic view of one embodiment of a rack of the rack assembly illustrated in FIG. 2.

FIG. 9 is a schematic view of another embodiment of a rack of the rack assembly illustrated in FIG. 2.

FIG. 10 is a side view of one embodiment of a rack of the rack assembly illustrated in FIG. 2.

FIG. 11 is a side view of another embodiment of a rack of the rack assembly illustrated in FIG. 2.

FIG. 12 is a schematic view of a portion of the rotatable grill assembly illustrated in FIG. 11.

FIG. 13 is a cross-sectional view of one embodiment of the adaptor of the rotatable grill assembly illustrated in FIG. 12 about line X-X.

FIG. 14 is a cross-sectional view of another embodiment of the adaptor of the rotatable grill assembly illustrated in FIG. 13 about line X-X.

FIG. 15 is a cross-sectional view of another embodiment of the adaptor of the rotatable grill assembly illustrated in FIG. 13 about line X-X.

FIG. 16 is a side view of a portion of one embodiment of the adaptor of the rotatable grill assembly illustrated in FIG. 12.

FIG. 17 is a detailed view of one embodiment of the portion of the rotatable grill assembly of FIG. 12 as indicated by circle Y.

FIG. 18 is a schematic view of another embodiment of a rack assembly.

FIG. 19 is a side view of the rack assembly of FIG. 18.

FIG. 20 is a schematic view of a portion of another embodiment of a rotatable grill assembly for use with the rack assembly of FIG. 18.

FIG. 21 is a schematic view of another embodiment of a rack assembly for use with the rotatable grill assembly illustrated in FIG. 20.

FIG. 22 is a schematic view of a portion of another embodiment of a rotatable grill assembly.

FIG. 23 is a schematic view of a portion of another embodiment of a rotatable grill assembly.

### DETAILED DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. In this regard, directional terminology, such as “upward,” “downward,” “top,” “bottom,” etc., is used with reference to the orientation of the figures being described. The rotatable grill assembly and related components of the present invention can be positioned in a number of different orientations. As such, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

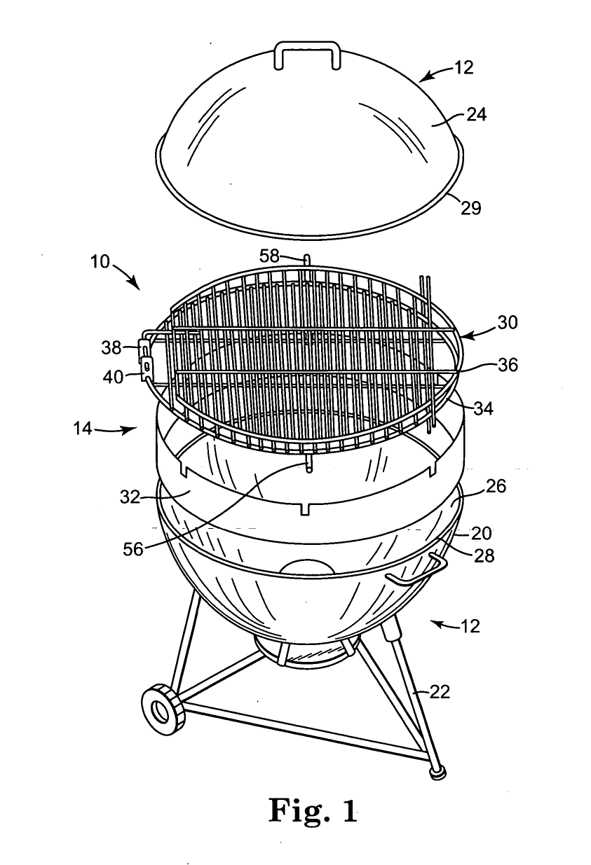

FIG. 1 illustrates one embodiment of a rotatable grill assembly generally at 10. Rotatable grill assembly 10 includes an existing grill 12 and a rotatable adaptor assembly 14. By adding rotatable adaptor assembly 14 to existing grill 12, existing grill 12 is converted from a conventional grill to a grill which facilitates simultaneous rotation of food items by rotatable grill assembly 10.

In one embodiment, conventional or existing grill 12 is any gas or charcoal grill commercially available and having a round or rectangular cross section. Conventional grill 12 includes a base 20, a stand or support 22, and a cover 24. In one embodiment, base 20 has a bowl or cup shape and, as such, defines an internal cavity 26, which terminates in a circular perimeter edge 28. Base 20 has an upright orientation such that perimeter edge 28 is the upper most portion of base 20. Stand or support 22 is connected to the exterior of base 20. Support 22 maintains base 20 off the ground and, more particularly, holds base 20 at a working height. Cover 24 has a dome-shape, which terminates in a circular edge or lip 29. Cover 24 is adapted to interact with base 20 to enclose cavity 24 of base 20. As such, circular edge 29 of cover 24 is sized to interact and/or mate with perimeter edge 28 of base 20. In addition, existing grill 12 typically includes a heating element (not shown), such as charcoal or gas, adapted to provide heat for the cooking, grilling, or smoking process. The heating element is typically maintained within cavity 26 of existing grill 12.

Adding rotatable adaptor assembly 14 converts existing grill 12 to a rotatable grill assembly 10. One embodiment of rotatable adaptor assembly 14 includes a rack assembly 30 and an adaptor 31. In one embodiment, adaptor 31 interfaces with existing grill 12 such that existing grill 12 with adaptor 31 can selectively receive rack assembly 30.

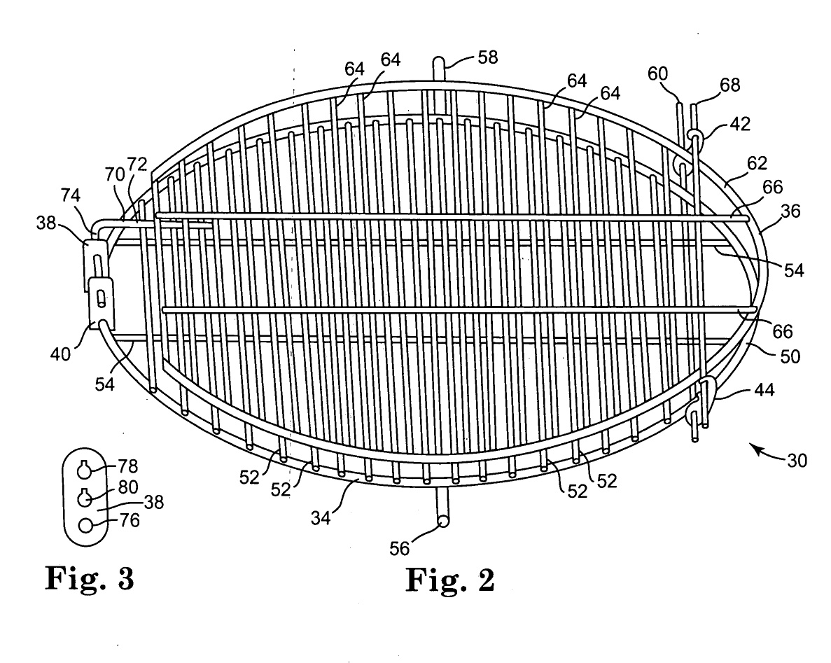

Referring to FIG. 2, one embodiment of rack assembly 30 includes a bottom rack 34, a top rack 36, pivot brackets 38 and 40, and clamps 42 and 44. Bottom rack 34 is selectively connected to top rack 36 via pivot brackets 38 and 40 and clamps 42 and 44. As such, bottom rack 34 and top rack 36 have a substantially similar position and a substantially similar shape. However, bottom rack 34 is spaced from top rack 36 such that food items to be prepared can be sandwiched and maintained between bottom rack 34 and top rack 36.

Bottom rack 34 is formed of wire or fabricated from expanded, stamped, formed metal pieces. In one embodiment, as illustrated in FIGS. 1 and 2, bottom rack 34 includes in perimeter rod 50 and a plurality of lateral rods 52. Perimeter rod 50 is shaped substantially similar to perimeter edge 28 of base 20. In one embodiment, perimeter rod 50 is slightly smaller than perimeter edge 28. As such, in the embodiment illustrated in FIG. 2, perimeter rod 50 forms a circle. The plurality of lateral rods 52 extend from one side of perimeter rod 50 to an opposing side of perimeter rod 50. Each of the plurality of lateral rods 52 is spaced from and parallel to the other plurality of lateral rods 52. The plurality of lateral rods 52 are spaced to prevent or decrease the likelihood that food will fall between any of the two lateral rods 52. As such, each of the plurality of lateral rods 52 is secured to perimeter rod 50.

In one embodiment, bottom rack 34 further includes at least one transverse rod 54, which runs perpendicular to lateral rods 52, to provide additional support and stability to bottom rack 34. Bottom rack 34 further includes journal or pivot arms 56 and 58 and rod extension or handle 60. Each journal 56 and 58 is secured to and extends radially from perimeter rod 50. In particular, journal 56 radially extends from perimeter rod 50 in the opposite direction that journal 58 radially extends from perimeter rod 50. Handle 60 is spaced from and has as parallel orientation to each journal 56 and 58. Handle 60 transverses and extends beyond perimeter rod 50. As such, handle 60 is secured to perimeter rod 50 at each point of intersection with perimeter rod 50.

Top rack 36 is formed of wire or fabricated from expanded, stamped, or formed metal pieces. In one embodiment, top rack 36 includes a perimeter rod 62 and a plurality of lateral rods 64 in a similar manner as described above with respect to bottom rack 34, perimeter rod 50, and the plurality of lateral rods 52. In one embodiment, top rack 36 further includes at least one transverse rod 66 in a similar manner as described above with respect to bottom rack 34 and transverse rod 54. Top rack 36 also includes a rod extension or handle 68 in a similar manner as described with respect to handle 60 of bottom rack 34. In addition, top rack 36 includes an L-shaped rod 70. L-shaped rod 70 includes a first section 72 and a second section 74, which is perpendicular to first section 72. L-shaped rod 70 is secured to top rack 36 opposite handle 68. In particular, first section 72 is secured to perimeter rod 62 and/or at least one of the plurality of lateral rods 64 such that first section 72 extends away from and substantially perpendicular to handle 68. Second section 74 extends from the distal end of first section 72 and is substantially parallel with handle 66. In one embodiment, second section 74 is substantially centered with respect to perimeter rod 62. In one embodiment, one side of top rack 36 terminates such that the side of top rack 36 is sized somewhat smaller than the corresponding side of bottom rack 34. In such an embodiment, L-shaped rod 70 extends from the terminated side of top rack 36.

Top rack 36 is connected to bottom rack 34 via pivot brackets 38 and 40. As illustrated in FIG. 3, pivot bracket 38 is an elongated piece of heat resistant material. Pivot bracket 38 defines at least two apertures 76 and 78, which are longitudinally spaced from one another along bracket 38. Aperture 76 is sized to receive perimeter rod 50. As such, pivot bracket 38 is formed around and coupled to perimeter rod 50 such that pivot bracket 38 extends upwardly from perimeter rod 50. In one embodiment, pivot bracket 38 is permanently welded to perimeter rod 50 at aperture 76 to fix the position of top rack 36 with respect to bottom rack 34. Aperture 78 is sized to rotatably receive second section 74 of L-shaped rod 70. Pivot bracket 40 is formed in substantially the same manner as pivot bracket 38. Pivot brackets 38 and 40 are positioned upon bottom rack 34 to correspond with the position of L-shaped rod 70 of top rack 36.

As such, top rack 36 is connected to bottom rack 34 by sliding second section 74 of L-shaped rod 70 through pivot brackets 38 and 40. Preferably, pivot brackets 38 and 40 are spaced from one another such that upon connection of top and bottom racks 34 and 36, top and bottom racks 34 and 36 are stabilized with respect to one another. In one embodiment, bottom rack 34 includes a second L-shaped rod (not shown), which is similar to but laterally spaced from L-shaped rod 70. In this embodiment, bracket 38 receives L-shaped rod 70, and bracket 40 receives the second L-shaped rod.

In one embodiment, pivot brackets 38 and 40 include at least one additional aperture 80, which is longitudinally spaced with respect to apertures 76 and 78. The additional aperture 80 provides a user with an additional connection option for top rack 36. In particular, L-shaped rod 70 of top rack 36 can be placed into either aperture 78 or 80 depending upon the thickness of the food to be cooked and, therefore, the desired spacing of the top and bottom racks 34 and 36.

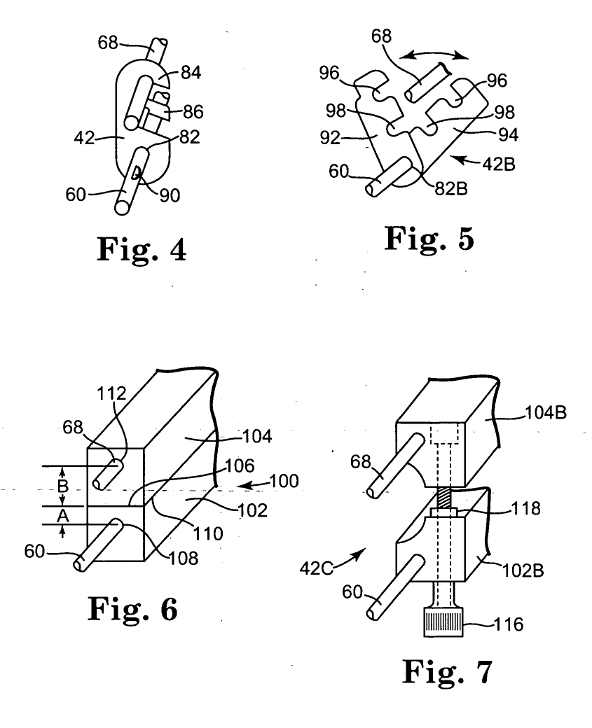

The position of bottom rack 34, with respect to top rack 36, is further stabilized by clamps 42 and 44. As illustrated in FIG. 4, in one embodiment, each clamp 42 and 44 is formed of an elongated piece of heat resistant material. Clamps 42 and 44 each include an aperture 82 and a hook 84 positioned longitudinally opposite aperture 82. Aperture 82 is sized to receive handle 60 of bottom rack 34 such that clamps 42 and 44 are rotatable about handle 60. Hook 84 is sized and positioned to receive and selectively retain handle 68 of top rack 36. In one embodiment, clamps 42 and 44 each include at least one additional hook 86 longitudinally spaced from hook 84 and aperture 82. Hook 86 is similarly shaped to receive and selectively retain handle 68 of top rack 36. The plurality of hooks 84 and 86 allow top rack 36 to be maintained with respect to bottom rack 34 at a variety of distances depending upon the thickness of the food to be grilled. In one embodiment, the handles 60 and 68 and clamps 42 and 44 utilize a spring loaded design.

In one embodiment, when L-shaped rod 70 is received by aperture 78 of pivot brackets 38 and 40, clamps 42 and 44 maintain handle 68 of top rack 36 via hook 84. Similarly, when L-shaped rod 70 is maintained by aperture 80 of pivot brackets 38 and 40, clamps 42 and 44 retain handle 68 via hook 86. Notably, the connection between bottom rack 34 and top rack 36 is such that upon releasing clamps 42 and 44, top rack 36 can be rotated about second section 74 of L-shaped rod 70, thereby, spacing top rack 36 from bottom rack 34 so food may be placed or removed from rack assembly 30. In one embodiment, handle 60 includes a protrusion 90 on one side of clamp 42 or 44 opposite the side the clamp 42 or 44 adjacent perimeter rod 50. Protrusion 90 prevents or at least decreases the likelihood that clamps 42 and 44 will slide off of handle 60.

FIG. 5 illustrates another embodiment of a clamp at 42. In this embodiment, clamp 42 includes a first portion 92 and a second portion 94. First portion 92 includes an aperture 82B sized and shaped to rotatably receive handle 60. Clamp 42 additionally defines at least one lateral slot 96 sized and shaped to receive handle 68. Clamp 42 is placed upon handle 60 such that when clamp 42 is rotated about handle 60 in a clockwise manner, lateral slot 96 will intercept and selectively receive handle 68. Second portion 94 is formed in a similar manner as described with respect to first portion 92. However, the position of second portion 94 with respect to handle 60 is inverted as compared to first portion 92. In other words, when second portion 94 is rotated counterclockwise about handle 60, lateral slot 96 intercepts and selectively receives handle 68. Thereby, interaction between lateral slots 96 of first portion 92 and second portion 94 both receive handle 68 to collectively and selectively retain handle 68 at a proper spacing from handle 60. In one embodiment, first portion 92 and second portion 94 each have at least one additional lateral slot 98 such that clamp 38 can maintain the spacing between bottom rack 34 and top rack 36 at one of at least two distances.

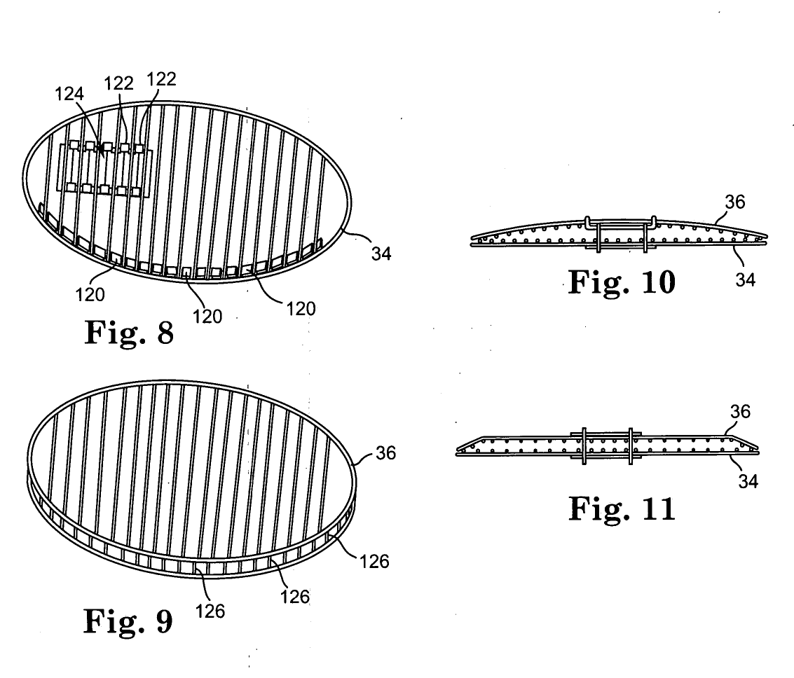

As illustrated in FIG. 6, in one embodiment, rack assembly includes a spacer assembly 100 that can be used with clamp 42, 44, or 42B. Spacer assembly 100 includes a first spacer 102 and a second spacer 104. In one embodiment, each spacer 102 and 104 is formed from a heat resistant material and is shaped as a block or cube. Spacer 102 defines a contact surface 106 and an internal channel 108 to receive handle 60. Similarly, spacer 104 defines a contact surface 110 and an internal channel 112 to receive handle 68. Upon selectively fixing top rack 36 with respect to bottom rack 34, contact surface 106 interacts with contact surface 110 to maintain the spacing between handles 60 and 68 at the desired distance. As such, contact surface 106 is defined at a distance A from internal channel 108, and contact surface 110 is defined at a distance B from internal channel 112. As such, internal channels, and thereby, handles 60 and 68 are maintained at a spacing equal to the distance A+B.

FIG. 7 illustrates another embodiment of clamp 42 generally at 42C. Clamp 42C incorporates spacers 102B and 104B. Spacers 102B and 104B are formed in a similar manner as described above with respect to spacers 102 and 104. In addition, clamp 42C includes a thumb screw 116 and a moveable stop 118. Thumb screw 116 penetrates and extends throughout spacer 102B and penetrates and terminates within spacer 104B. In one embodiment, thumb screw 116 is substantially perpendicular with respect to handles 60 an 68. Moveable stop 118 is located along thumb screw 116 between spacer 102B and 104B. Moveable stop 118 is longitudinally moveable along thumb screw 116, by virtue of the threads of thumb screw 116, to a desired position to effectively maintain spacers 102B and 104B, and therefore handles 60 and 68, at a desired spacing.

In another embodiment, clamp 42 is any heat resistant clamp design sufficient to hold the top and bottom racks 34 and 36 at at least one desired distance or spacing. In one embodiment, clamp 42 is an over-center clamp, a spring clamp, a toggle clamp, an adjustable hinged clamp, a plunger clamp, or a push-pull clamp. In another embodiment, clamp 42 is a snap or latch. Notably, in one embodiment, clamp 44 is similar to clamp 42. In another embodiment, clamp 44 and clamp 42 exemplify different embodiments as described above with respect to clamp 42, 42B, and 42C.

FIGS. 8 and 9 illustrate additional or alternative configurations of rack assembly 30. FIG. 8 illustrates bottom rack 34 including a retaining mechanism or plurality of external tabs 120 which extend upwardly from perimeter rod 50 to further facilitate maintenance of the food between bottom rack 34 and top rack 36. Each of the plurality of tabs is formed of a heat resistant and substantially rigid material. In one embodiment, bottom rack 34 includes one or more internal tabs 122, similar to the plurality of external tabs 120, which form an internal food maintenance area 124. Internal tabs 122 are adapted to hold and maintain food within defined maintenance area 124. In one embodiment, top rack 36 also or alternatively includes plurality of tabs 120 and/or 122. In one embodiment, retaining mechanism is a continuous external wall (not shown) extending upwardly from perimeter rod 50 to facilitate maintenance of the food between the top and bottom racks 34 and 36. In one embodiment, at least one continuous internal wall (not shown) forms an internal food maintenance area independently of or in concert with the external continuous wall.

FIG. 9 illustrates one embodiment of rack assembly 30 in which top rack 36 includes a plurality of vertical rods 126 which extend vertically downward from perimeter rod 62 to facilitate maintenance of food between top and bottom racks 34 and 36. In another embodiment, bottom rack 34 includes a plurality of vertical rods (not shown), which extend vertically upward from perimeter rod 50 for similar purposes as described with respect to the plurality of vertical rods 126.

FIGS. 10 and 11 illustrate alternative embodiments for top rack 36. In one embodiment as illustrated in FIG. 10, top rack 36 has a dome shape, which is inverted with respect to bottom rack 34. The dome shape of top rack 36 gradually decreases the space between top and bottom racks 34 and 36 near their perimeter rods 50 and 62. Decreasing the space between racks at 34 and 36 decreases the likelihood of food sliding out from between the two racks 34 and 36. In another embodiment as illustrated in FIG. 11, top rack 36 is angled toward bottom rack 34 near perimeter rod 62 such that perimeter rods 50 and 62 are located in relative proximity to one another. The angled top rack 36 decreases the likelihood of food sliding out from between the two racks 34 and 36.

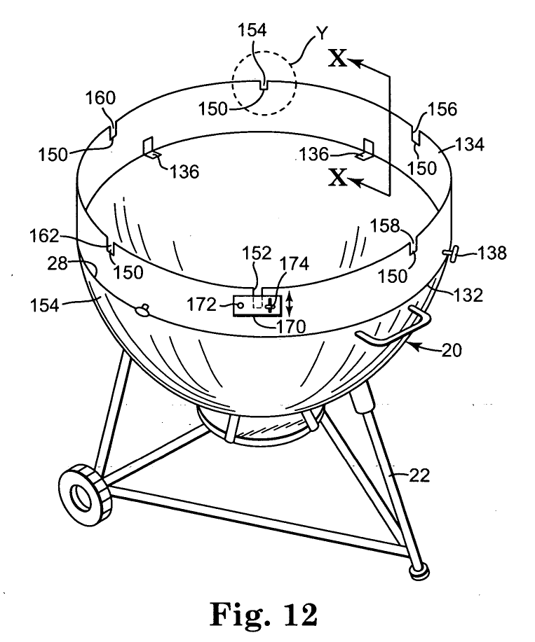

As described above and as illustrated in FIGS. 1 and 12, adaptor 31 interfaces with existing grill 12, such that existing grill 12 with adaptor 31 can selectively and rotatably receive rack assembly 30. In one embodiment, adaptor 31 includes an adaptor ring 32. Adaptor ring 32 includes an upright wall extension 130, which defines a bottom edge 132 and a top edge 134. Wall extension 130 is adapted to essentially extend base 20, thereby, increasing a depth of internal cavity 26. The increased depth of internal cavity 26 allows the rack assembly to more easily rotate upon adaptor ring 32 without contacting the heating element (not shown) contained within base 20.

Wall extension 130 interacts with base 20 to contain the heat and airflow of the original grill. In other words, heat and airflow loss at the intersection of wall extension 130 and base 20 is discouraged. Wall extension 130 upwardly extends from bottom edge 132 to top edge 134. In one embodiment, wall extension 130 extends with a substantially vertical or a slightly inclined orientation from bottom edge 132 to top edge 134. In one embodiment, bottom edge 132 interacts with perimeter edge 28 in a similar manner as top edge 29 of cover 24 was originally designed to interact with perimeter edge 28. In another embodiment, wall extension 130 does not attach to perimeter edge 28 but, rather, attaches to another upper portion of base 20.

In one embodiment, adaptor ring 32 includes a number of tabs or connection brackets 136 that are attached to the inside of wall extension 130 near bottom edge 132. Upon positioning of extension wall 130 upon base 20, connection brackets 136 interact with or are selectively attached to base 20. In one embodiment, connection brackets 136 are attached to extension wall 130 and/or selectively attached to base 20 by rivets, screws, or other heat resistant connection device or medium. In one embodiment, adaptor ring 32 also includes at least one fastener 138 that is adapted to selectively lock adaptor ring 32 to base 20. Notably, in one embodiment, at least a portion of the number of tabs or connection brackets 136 are attached to the outside of wall extension 130 near bottom edge 132. Accordingly, connection brackets 136 attach to the inside and/or the outside of base 20.

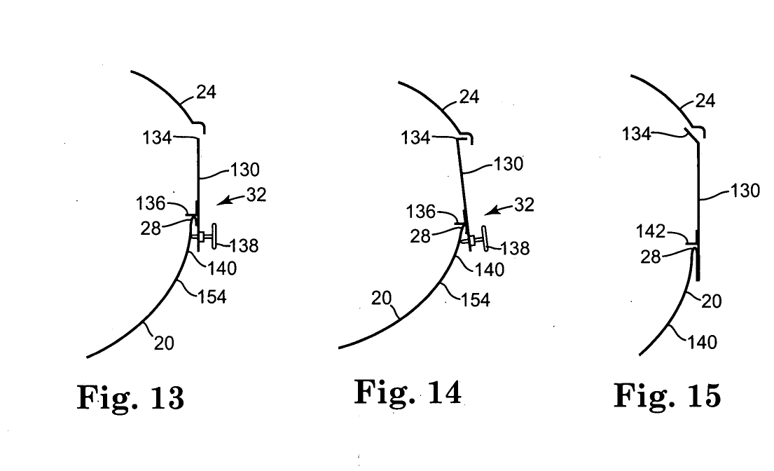

In one embodiment as illustrated in FIG. 13, bracket 136 interacts with perimeter edge 28 of base 20, thereby, stabilizing wall extension 130 with respect to base 20. Fastener 138 tightens to selectively interact with exterior surface 140 of base 20. As such bracket 136 and fastener 138 collectively interact with base 20 to selectively secure wall extension 130 to base 20. Notably, loosening fastener 138 allows adaptor ring 32 to be adjusted upon or removed from existing grill 12. Although wall extension 130 is illustrated as substantially vertical in FIG. 13, wall extension 130 may taper to the top edge 134 to facilitate interaction with cover 24, as illustrated in FIG. 14. In one embodiment, tapered wall extension 130 allows for some variability in the perimeter distance of base 20 and cover 24.

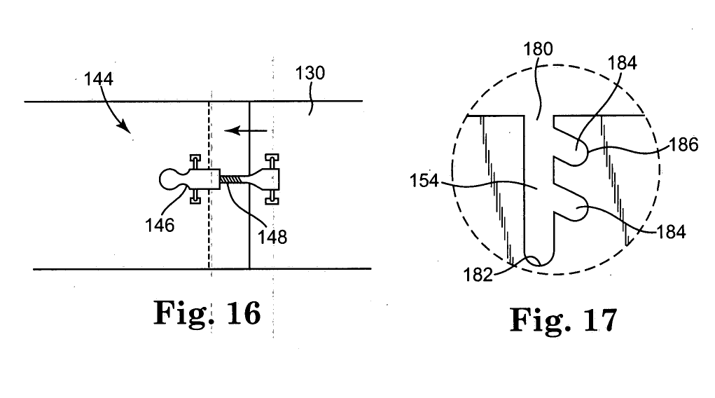

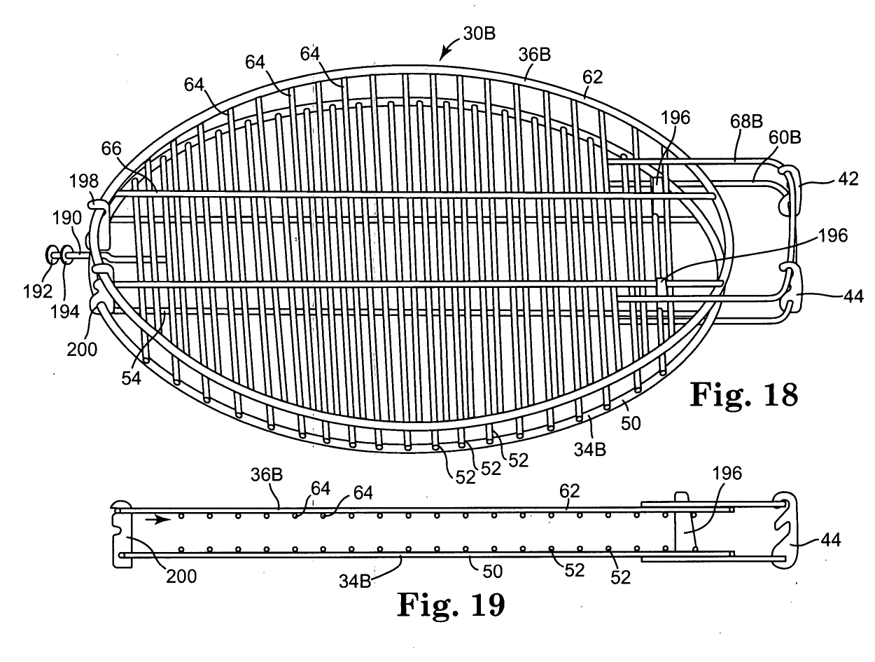

In one embodiment illustrated in FIG. 15, adaptor ring 32 includes wall extension 130 with a continuous rib 142, which extends inwardly from wall extension 130, rather than brackets 136. In one embodiment also illustrated in FIG. 15, wall extension 130 may have a beveled or angled top edge 134 to facilitate reception of cover 24. In another embodiment illustrated in FIG. 16, adaptor ring 32 includes an adjustment mechanism 144 that is connected to a non-continuous wall extension 130 to adapt and lock wall extension 130 at various sizes such that adaptor ring 32 is capable of converting multiple sizes of existing grills 12. In one embodiment, adjustment mechanism 144 includes at least one over-the-center clamp 146 with an adjustable arm 148. Adjustable arm 148 can be pulled or pushed to size adaptor ring 32 to fit base 20. Upon properly positioning adjustable arm 148 with respect to clamp 146, clamp 146 is tightened to hold adaptor ring 32 at a desired size.

In one embodiment, illustrated in FIG. 1, top edge 132 is adapted to receive cover 24 of existing grill 12. In another embodiment, top edge 132 is adapted to receive a new grill cover (not shown). In one embodiment, top edge 132 forms a plurality of notches 150 to selectively receive and maintain rack assembly 30. In particular, in one embodiment illustrated in FIG. 12, the plurality of notches 150 are spaced around top edge 134 to receive journals 56 and 58 and at least one of handles 60 and 68 of rack assembly 30. As such, in one embodiment, the plurality of notches 150 includes fulcrum notches 152 and 154 and handle receiving notches 156, 158, 160, and 162. Fulcrum notches 152 and 154 are sized and shaped to receive and support journals 56 and 58, respectively. As such, journals 56 and 58 are adapted to be supported by and to rotate within fulcrum notches 152 and 154, respectively.

Receiving notches 156-162 are sized and shaped to selectively receive handles 60 and 68. In one embodiment, receiving notches 156 and 158 receive handle 60 when rack assembly 30 is in its original position with respect to adaptor ring 32. As rack assembly 30 is rotated about journals 56 and 58 within fulcrum notches 152 and 154, handle 60 is removed from receiving notches 156 and 158 and is received by receiving notches 160 and 162. In one embodiment, fulcrum notches 152 and 154 and receiving notches 156-162 are simple notches, as illustrated in FIG. 12, and are only adapted to receive journals 56 and 58 and handles 60 and 68 at a single height.

In grilling it is often desirable to raise and lower the food with respect to the heating element to vary the cooking rate. As such, in one embodiment, adaptor ring 32 additionally includes a positioning plate 170, a rotatable connection device 172, and an adjustable connection device 174. Positioning plate 170 is connected to wall extension 130 such that positioning plate 170 extends across notch 152. Rotatable connection device 172 rotatably secures positioning plate 170 to wall extension 130 on one side of notch 152. Connection device 172 is any heat resistant connection device capable of securing positioning plate 170 to wall extension 130 while still allowing positioning plate 170 to rotate around connection device 172.

Adjustable connection device 174 secures positioning plate 170 to wall extension 130 on the opposite side of the notch with respect to connection device 172. Adjustable connection device 174 is any heat resistant connection device adapted to allow the position of positioning plate 170 to be adjusted in a substantially linearly manner. As such, adjustment of connection device 174 causes positioning plate 170 to pivot about connection device 172. As plate 170 pivots, the height of plate 170 with respect to the notch 152 is varied. Since plate 170 is positioned above the support surface of notch 152, rack assembly 30 will be supported by plate 170, rather than by the surface of notch 152. Therefore, adjusting the height of plate 170 adjusts the height at which rack assembly 30 will be maintained above the heating element (not shown) within base 20. Notably, in one embodiment, positioning plate 170 and connection devices 172 and 174 are also connected at fulcrum notch 154 and/or receiving notches 156-162.

In an alternative embodiment, notches 152-162, themselves, are adapted to receive journals 56 and 58 and handles 60 and 68 at various, or rather at least two, heights. One embodiment of a variable height notch, whether a fulcrum or receiving notch, is illustrated in FIG. 17. Fulcrum notch 154 is representative of other notches 152 and 156-162. As such, it should be noted that one and or more of the notches 152-162 may be adapted to receive journals 56 or 58 or handle 60 or 68 at various heights. Notch 154 defines an open end 180 and a closed end 182. In order to accommodate various height positions of rack assembly 30, notch 154 further includes at least one slot 184 that extends at a downward angle from notch 154. In particular, slot 184 extends at a downward angle from notch 154, i.e. substantially towards closed end 182. As such, journal 58 may be supported by closed end 182 of notch 154 or by a closed end 186 of slot 184. Notably, each closed end 182 and 186 selectively maintains rack assembly 30 at a different height. In one embodiment, notch 154 includes a plurality of slots 184. In one embodiment, fulcrum notch 152 also includes at least one slot 184. In one embodiment, receiving notches 156-162 also include at least one slot 184.

Once adaptor ring 32 has been secured to base 20, rotatable grill assembly 10 is ready for use. During use, rack assembly 30 is loaded with food to be grilled, cooked, or smoked. In particular, top rack 36 is separated and/or rotated away from bottom rack 34. The food is loaded on bottom rack 34, and top rack 36 is replaced and secured at a desired spacing from bottom rack 34, wherein the desired spacing is dependent upon the thickness of the food to be prepared. In one embodiment, top rack 36 is secured to bottom rack 34 by engaging clamps 42 and 44 with top rack 36. Notably, rack assembly 30 allows the rack to be separated from the remaining portions of rotatable grill assembly 10, namely existing grill 12 and adaptor ring 32. As such, in one embodiment, rack assembly 30 is removed from adaptor ring 32 and loaded with food at a site away from grill assembly 10.

Upon loading, rack assembly 30 is replaced upon adaptor ring 32 for grilling. In particular, rack assembly 30 is placed on adaptor ring 32 such that journals 56 and 58 are received by fulcrum notches 152 and 154, respectively. In one embodiment, rack assembly 30 is initially placed on adaptor ring 32 such that handle 60 is received by receiving notches 156 and 158. Cover 24 is replaced over grill assembly 10 to hold the smoke and heat generated by the heating element (not shown) within grill cavity 26.

When a user deems appropriate, cover 24 is removed and rack assembly 30 is rotated to expose an opposite side of the food to the heating element (not shown). In particular, rack assembly 30 is rotated about journals 56 and 58 as supported by fulcrum notches 156 and 158. As rack assembly 30 is rotated, handle 60 is removed from receiving notches 156 and 158, and handle 68 is received by receiving notches 160 and 162. Notably, rack assembly 30 can also be rotated to return handle 60 to notches 156 and 158. Following rotation of rack assembly 30, a user replaces cover 24 on grill assembly.

Rack assembly 30 can be repeatedly rotated as deemed appropriate by the user until the user deems the food to be cooked to his or her satisfaction. Cover 24 is removed, and clamps 42 and 44 release top rack 36. Top rack 36 is separated or rotated away from bottom rack 34. The food is removed from bottom rack 34. In one embodiment, rack assembly 30 is moved to a site away from existing grill 12 and adaptor ring 32 before top rack 36 is removed and/or rotated and, therefore, before the food is removed from bottom rack 34.

FIGS. 18 and 19 illustrate an alternative embodiment of rack assembly 30 generally at 30B. Rack assembly 30B includes a bottom rack 34B and a top rack 36B. Racks 34B and 36B include perimeter rods 50 and 62, the plurality of lateral rods 52 and 64, and the optional transverse rods 54 and 66 in a similar manner as described above with respect to racks 34 and 36. However, bottom rack 34B includes a rear pivot arm 190, which radially extends from perimeter rod 50. An exterior stop 192 and an interior stop 194 each circumscribe a small portion of pivot arm 190. Stops 192 and 194 are located towards the outermost portion of pivot arm 190. Stop 194 is longitudinally spaced from exterior stop 192 such that interior stop 194 is positioned between exterior stop 192 and perimeter rod 50.

Bottom rack 34B further includes a handle 60B. In one embodiment, handle 60B is a substantially U-shaped, heat-resistant rod. Handle 60B is secured to rods 50 and/or 52 of bottom rack 34B, opposite rear pivot arm 190. In particular, handle 60B is substantially centered on bottom rack 34B with respect to rear pivot arm 190. Bottom rack 34B additionally includes at least one tapered bracket 196. Tapered bracket 196 is formed of heat resistant material and is secured to at least one lateral rod 52 and/or transverse rod 54. Tapered bracket 196 gradually tapers and extends upwardly and substantially vertically from bottom rack 34B. In one embodiment, tapered bracket 196 is located relatively near handle 60. Top rack 36B further includes handle 68B. Handle 68B is similar to handle 60B and, as such, is secured to rods 62 and or 64 in a similar manner as described with respect to rods 50 and 52 of bottom rack 34B.

Top rack 36B is connected to bottom rack 34B via locator brackets 198 and 200. Locator brackets 198 and 200 are elongated pieces of heat resistant material and are formed in a similar manner as described above with respect to clamps 42 and 44. As such, the perimeter rod 50 is threaded through the apertures of locator brackets 198 and 200 and secured to locator brackets 198 and 200. In one embodiment, the locator brackets 198 and 200 are located relatively near and collectively are substantially centered around rear pivot arm 190. In particular, locator brackets 198 and 200 are positioned such that the hooks of the brackets 198 and 200 face away from the center of bottom rack 34B. Perimeter rod 62 of top rack 36B is received by the hooks of brackets 198 and 200.

The at least one lateral rod 64 of top rack 34B interacts with the at least one tapered bracket 196 of bottom rack 34B. In particular, as top rack 36B is lowered toward bottom rack 34B, lateral rod 64 interacts with a tapered surface of tapered bracket 196, which is distally located with respect to locator brackets 198 and 200 of tapered bracket 196. As top rack 36B continues to be lowered toward bottom rack 34B, the interaction between lateral rod 64 and tapered bracket 196 puts top rack in tension, which facilitates maintenance of perimeter rod 62 within the lateral notches of locator brackets 198 and 200. In one embodiment, clamps 42 and 44 facilitate maintenance of top rack 36B at a desired spacing from bottom rack 34B. Handle 60B is threaded through aperture 82 of clamps 42 and 44 such that clamps 42 and 44 can rotate about handle 60B. As clamps 42 and 44 are rotated hook 84 or 86 receives and selectively maintains handle 68B of top rack 36B.

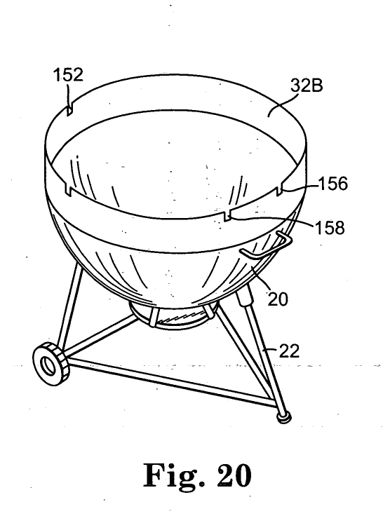

FIG. 20 illustrates an adaptor ring 32B adapted to receive rack assembly 30B. Adaptor ring 32B is substantially similar to adaptor ring 32, described above. However, a top edge 134B of adaptor ring 32B forms a single fulcrum notch 152 and receiving notches 156 and 158. Fulcrum notch 152 receives pivot arm 190 such that adaptor ring 32B is positioned between exterior stop 192 and interior stop 194. Receiving notices 156 and 158 receive and selectively support handle 60B or 68B. Rack assembly 30B is used in substantially the same manner as described above with respect to rack assembly 30. However, when a user deems appropriate, rack assembly 30B is rotated about pivot arm 190 to expose a second side of the food to the heating element (not shown). Upon rotation, handle 60B is lifted from notches 156 and 158, rack assembly 30B is rotated, and handle 68B is received by notches 156 and 158. In one embodiment, since rack assembly 30B is lifted prior to rotation, adaptor ring 32B is shorter than adaptor ring 32 or is eliminated.

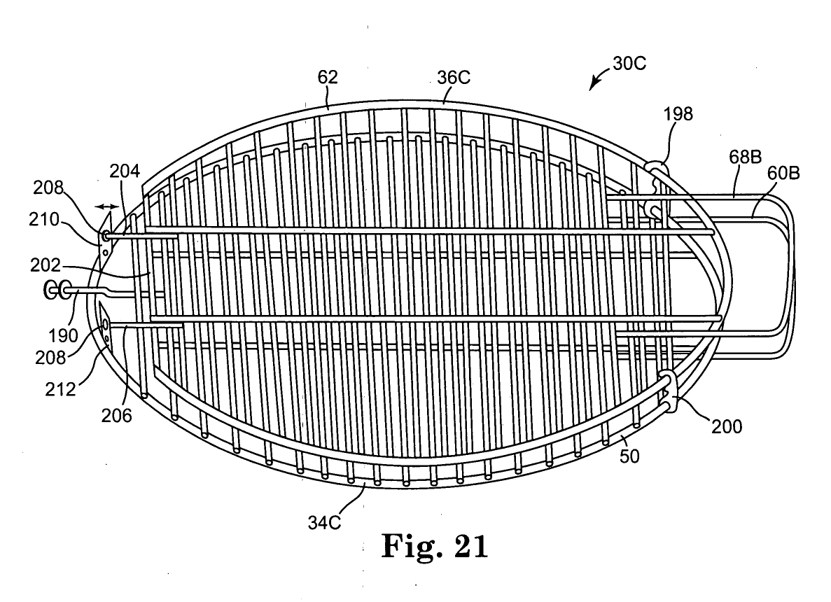

FIG. 21 illustrates one embodiment of a variation of rack assembly 30B generally at 30C. Rack assembly 30C includes a bottom rack 34C and a top rack 36C which are substantially similar to bottom rack 34B and top rack 36B. However, a perimeter rod 62 of top rack 36C terminates opposite a handle 68B to form a flat edge 202. A first connection arm 204 and a second connection arm 206 are secured to flat edge 202 and/or lateral rods 64 and extends substantially parallel to pivot arm 190 of the corresponding bottom rack 34C. A stop 208 is secured to each connection arm 204 and 206 near the outermost end of each arm 204 and 206.

Top and bottom racks 34C and 36C are connected by locator brackets 198 and 200 and spring steel brackets 210 and 212. In this embodiment, locator brackets 198 and 200 are secured to perimeter rod 50 relatively near handle 60B. Spring steel brackets 210 and 212 are secured to perimeter rod 50 of bottom rack 34C. Collectively, brackets 210 and 212 are substantially centered about pivot arm 190. Brackets 210 and 212 each include a plurality of longitudinally spaced apertures 208 sized to receive connection arms 204 and 206, respectively. Top rack 36C is connected to bottom rack 34C by positioning the connection arms 204 and 206 in the appropriate apertures of spring steel brackets 210 and 212 such that each stop 208 is positioned between one bracket 210 or 212 and flat edge 202. Pressure is applied to handle 68B to push top rack 36C toward brackets 210 and 212 until perimeter rod 62 of top rack 36C can be received by the appropriate hook 84 or 86 of each locator bracket 198 and 200. Rack assembly 30C is used in substantially the same manner as described with respect to rack assembly 30B.

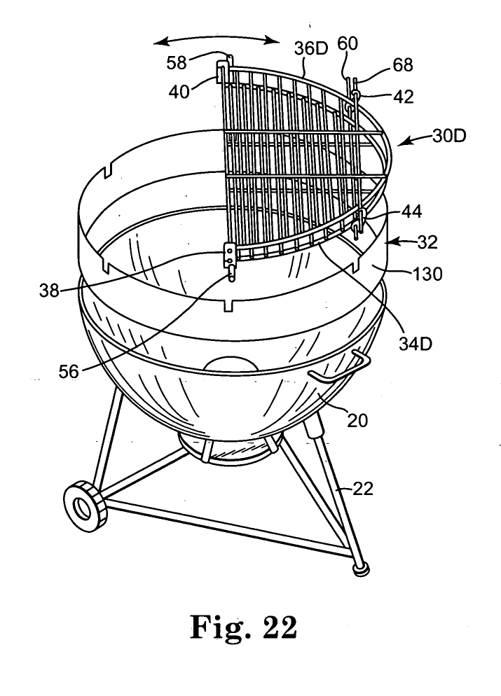

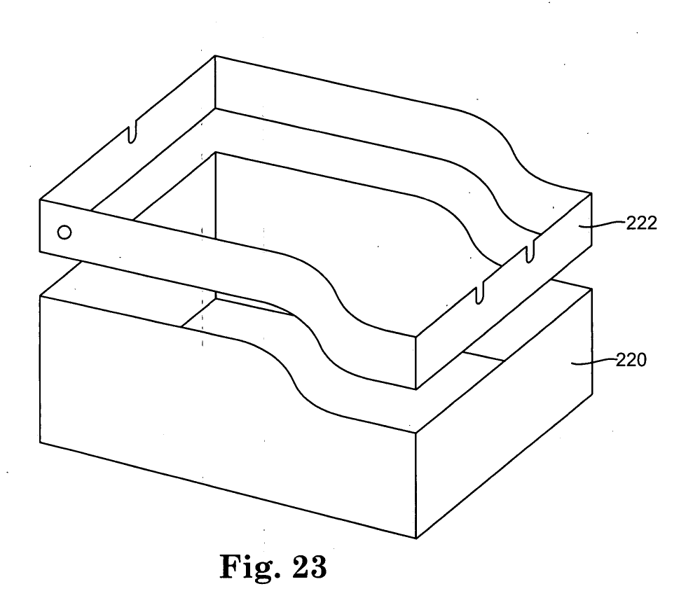

Another embodiment of a rack assembly is generally illustrated in FIG. 22 at 30D. Rack assembly 30D is substantially similar to rack assembly 30. Accordingly, rack assembly 30D includes journals 56 and 58 in a similar manner as described with respect to rack assembly 30. Rack assembly 30D is rotated about journals 56 and 58 to turn the food, thereby, exposing the opposite side of the food to the heating element (not shown). However, the bottom and top racks 34D and 36D are substantially half the size of top edge 134 of adaptor ring 32. As such, when top rack 36D is rotated about pivot brackets 38 and 40, top handle 68 is rotated from a position above bottom handle 60, which is selectively maintained by notches 156 and 158, to be selectively maintained by notches 160 and 162. In this embodiment, top rack 36D and bottom rack 34D can be simultaneously supported by adaptor ring 32 while loading food to bottom rack 34D at the grill site. In one embodiment that utilizes rack assembly 30D, adaptor ring 32 is eliminated or is shorter than adaptor ring 32 used with rack assembly 30 because rack assembly 30D does not rotate into the interior of base 20.

It should be noted that although the embodiments described above relate primarily to a round grill, existing grill 12 could be rectangular or have any other shape, for example as illustrate in FIG. 23. As a result, rack assembly 30 and adaptor ring 32 can be modified to correspond to the particular shape of existing grill 12. For example, a rectangular existing grill 220 would likely be selectively coupled with a rectangular adaptor ring 222.

In addition, in one embodiment, the adaptor includes at least one adaptor bracket (not shown), rather than adaptor ring 32 or 32B. When added to base 20 of existing grill 12, the at least one adaptor bracket modifies base 20 to rotatably receive journals 56 and 58 or 190. In one embodiment, adaptor 31 includes additional adaptor brackets, which are selectively coupled to base 20 to selectively receive handles 60, 68, 60B, and/or 68B. In one embodiment, adaptor bracket and any additional brackets each include at least one notch. The notch or notches of the at least one adaptor bracket and/or additional brackets functions in a similar manner as described above with respect to notches 150 of adaptor ring 32 or 32B. Furthermore, although described above as a modification to an existing grill 12, the rotatable adaptor assembly 14 may be incorporated into original grill design and manufacture. In one embodiment, adaptor 31 is integrally formed with base 20.

The rotatable grill assembly facilitates even cooking of food items and limits the amount of time a user is exposed to the heat and smoke produced by a grill. The rotatable adaptor assembly converts grills of all type and shapes into rotatable grill assemblies. The rack assembly of the rotatable adaptor assembly captures and holds the food while it is being cooking or rotated. The rack assembly is easy open to allow a user to interact with the food contained within the rack assembly at the grill or other relatively remote location. For at least these reasons, the rotatable grill assembly provides a precise, convenient, and improved method of grilling.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A grill assembly comprising:
a rack assembly including a first rack spaced from and connected to a second rack opposite the first rack; and
an adaptor adapted to attach to an existing grill and adapted to rotatably receive the rack assembly.

2. The grill assembly of claim 1, wherein the rack assembly is rotatable relative to the adaptor such that the adaptor is configured to receive the first rack at a first time instance and the second rack at a second time instance.

3. The grill assembly of claim 1, wherein the first rack includes at least one journal and the adaptor includes at least one notch adapted to receive the at least one journal, the rack assembly being rotatable about the at least one journal.

4. The grill assembly of claim 3, wherein the at least one journal radially extends from the first rack.

5. The grill assembly of claim 3, wherein the at least one journal includes a first journal and a second journal, the first journal radially extending from the first rack and the second journal radially extending from first rack opposite the first journal.

6. The grill assembly of claim 1, wherein the first rack defines a perimeter, the first rack including a retaining mechanism about the perimeter, the retaining mechanism substantially bridging the space between the first rack and the second rack.

7. The grill assembly of claim 1, wherein the first rack is shaped to gradually decrease the space between the first rack and the second rack between an interior region and a perimeter of the first rack.

8. The grill assembly of claim 1, wherein the adaptor is adapted to receive the rack assembly at a plurality of distances from a base of the existing grill.

9. The grill assembly of claim 1, wherein the first rack is selectively connected to the second rack.

10. The grill assembly of claim 1, wherein the first rack is rotatably connected to the second rack.

11. The grill assembly of claim 1, wherein the adaptor includes an adaptor ring having a first edge and a second edge opposite the first edge, the first edge being adapted to attach to the existing grill, the second edge adapted to rotatably receive the rack assembly, wherein the adaptor ring increases the interior depth of the existing grill.

12. The grill assembly of claim 1, wherein the existing grill has a round base.

13. A grill assembly comprising:
a rack assembly including a first rack spaced from and connected to a second rack opposite the first rack, the first rack including at least one radially extending journal, wherein the rack assembly is rotatable about the at least one journal;
a grill base defining a cavity; and
and adaptor secured to the grill base, the adaptor defining at least one notch to receive the at least one radially extending journal, wherein the at least one notch is adapted to selectively maintain the at least one radially extending journal in a plurality of distances from the edge of the grill base.

14. The grill assembly of claim 13, wherein the adaptor includes an adaptor ring, wherein the adaptor ring is selectively secured to the existing grill to increase interior depth of the cavity.

15. The grill assembly of claim 13, wherein the first rack is selectively connected to the second rack.

16. The grill assembly of claim 13, wherein the first rack defines a perimeter, the first rack including a retaining mechanism about the perimeter, the retaining mechanism substantially bridging the space between the first rack and the second rack.

17. The grill assembly of claim 13, wherein the rack assembly is rotatable relative to the grill base such that the edge of the adaptor is configured to receive the first rack at a first time instance and the second rack at a second time instance.

18. The grill assembly of claim 13, wherein the first rack is shaped to gradually decrease the space between the first rack and the second rack between an interior region and a perimeter of the first rack.

19. The grill assembly of claim 13, wherein the grill base is round.

20. A method of converting an existing grill into a rotatable grill assembly, wherein the existing grill includes a base which defines a cavity, the method including:
securing an adaptor to the base; and
placing a rack assembly on the adaptor, the rack assembly including a first rack spaced from and connected to a second rack opposite the first rack, wherein the adaptor rotatably maintains the rack assembly.

21. The method of claim 20, wherein the adaptor includes an adaptor ring to increase the overall depth of the cavity, the adaptor ring including a first edge and a second edge opposite the first edge, the first edge being adapted to be secured to the base, and wherein the second edge of the adaptor ring rotatably maintains the rack assembly.

22. The method of claim 20, wherein the rack assembly is rotatable relative to the adaptor such that the adaptor is configured to receive the first rack at a first time instance and the second rack at a second time instance.

23. The method of claim 20, wherein the first rack includes at least one journal, the rack assembly being rotatable about the at least one journal, and the adaptor includes at least one notch adapted to maintain the at least one journal, further wherein placing the rack assembly on the adaptor includes placing the at least one journal in the notch of the adaptor.

24. The method of claim 23, wherein placing the rack assembly on the adaptor includes selecting a position of the at least one journal in the notch from one of a plurality of positions in the notch adapted to maintain the at least one journal.
